(19) United States
(12) Patent Application Publication
(10) Pub. No.: US 2022/0411997 A1
(43) Pub. Date: Dec. 29, 2022

(54) Insect-Resistant Fabrics Including Micellar Systems

(71) Applicant: Burlington Industries LLC, Greensboro, NC (US)

(72) Inventors: Kiarash Arangdad, Cary, NC (US); William J. DiIanni, Kernersville, NC (US); Nelson F. Bebo, III, Greensboro, NC (US)

(21) Appl. No.: 17/847,598

(22) Filed: Jun. 23, 2022

Related U.S. Application Data
(60) Provisional application No. 63/213,896, filed on Jun. 23, 2021.

(51) Int. Cl. D06M 23/12; D06B 1/02; D06M 13/148; D06M 23/16; A01N 25/10; A01N 31/08; A01N 37/38; A01P 17/00; A01N 65/28; A01N 65/36

(52) U.S. Cl. CPC D06M 23/12; D06B 1/02; D06M 13/148; D06M 23/16; A01N 25/10; A01N 31/08; A01N 37/38; A01P 17/00; A01N 65/28; A01N 65/36; D10B 2501/00

(57) ABSTRACT

The present disclosure is directed to insect-resistant fabrics or garments and methods for making the same. The insect-resistant fabrics or garments include an insect repelling composition containing a micellar system and optionally an insecticide composition. As an example, an insect-resistant fabric in accordance with the disclosure can include a base fabric (e.g., polyester) having been treated to include an insect repellant composition containing a micellar system. The micellar system may include one or more insect repelling agents (e.g., essential oils) contained within one or more micelles (e.g., saponins) in a first region of the fabric, and optionally an insecticide (e.g., permethrin) in second region of the base fabric. The inclusion of a micellar system in an insect repellant composition is shown herein to provide improved insect-resistant efficacy. Additionally, certain insect-resistant fabrics disclosed herein can also demonstrate durability when exposed to wear such as laundering the garment.

### RELATED APPLICATIONS

The present application is based upon and claims priority to U.S. Provisional Patent Application Ser. No. 63/213,896, filed on Jun. 23, 2021, and which is incorporated herein by reference.

### BACKGROUND

Vector borne diseases cause thousands of deaths annually where many of these diseases are preventable through protective measures. There are some commercially available spray or lotion insect repellents which can be topically applied to skin or clothing, but these are not durable to washes. Insecticide treated fabric and/or garment are intended to reduce biting by mosquitos and possibly other insects. Synthetic pyrethroids, such as permethrin, exhibit knockdown and kill activity with long term protection for users. It has been applied to the garment and/or fabrics by dipping, spraying, and polymer coating methods. For example, garments have been impregnated with permethrin in an industrial washing machine having a rotatable drum. U.S. Pub. No. 2012/0100198A1 discloses permethrin-treated garment where the garment has been sprayed with an aqueous emulsion which contains approximately 40% by weight permethrin. Regarding fabric application, U.S. Pub. No. 2010/0119720A1 teaches methods for insecticidal impregnation of netting and fabrics. In other examples, pyrethroids were added to fabrics during the dyeing process where the fabric is immersed in a dye bath containing permethrin (exhaust dyeing solution). The major challenge of permethrin-treated textiles has been wash durability and persistency. Poor washing fastness of pyrethroid-treated fabrics has been enhanced by adding polymeric binding and crosslinking agents in the finishing formula. Decomposition of pyrethroid into a nonactive insecticidal product in the presence of ultraviolet light have still negative impacts on the persistency and efficacy of treated fabrics. However, degradation of pyrethroid, such as permethrin in presence of light and oxygen, can be prevented by including a barrier layer, as taught in U.S. Pat. No. 5,252,387.

There is still serious threat to wearer protection when pyrethroids-treated fabric and garments do not prevent vector mosquitoes from landing. Repellent active ingredients interfere in the attraction mechanism of insects. Unlike insecticide materials, insect repellent agents are used to drive away insects, so the agents act not as contact poison to kill insects but to repel them before probing and biting. Generally, insect repellent agents may be applied to a variety of fabrics with or without the additional presence of an insecticide. In one example, an aqueous dispersion of an amine insect repellent such as N,N′-diethyl-m-toluamide (DEET), with substituted organosilane and silanol functional polymer, was applied on fabric. Spatial repellants containing plant-based ingredients, such as citronella oil, rosemary oil and eucalyptus oil, have gained popularity among consumers when they are perceived to be safe and environmentally sustainable. For instance, a strip of finished fabric (polyester/cotton) with aromatic oils was attached to a headwear in order to provide bite prevention. The efficacy and longevity of these natural repellents is restricted due to the volatility of its components. Moreover, fabrics treated with insect repellant agents generally tend to have poor wash durability and persistency. Specifically, fabrics treated with insect repellant agents may lose substantial insect repelling efficacy after multiple wash cycles and normal wear.

Prior bite protective substrates do not provide long lasting concurrent repellency and insecticidal efficacies. There remains a need for enhanced bite protective fabric/garment. Moreover, there remains a need for an insect repellant-treated fabric that is durable and persistent after multiple wash cycles and normal wear. Additionally, there remains a need for a safe and environmentally sustainable insect-repellant treated fabric that is similarly durable and persistent after multiple wash cycles and normal wear. The present disclosure provides examples to address certain shortcomings in the art by utilizing an insect repellant composition containing a micellar system, and, optionally, an insecticide composition.

### SUMMARY OF THE INVENTION

The present disclosure is directed to insect-resistant fabrics or garments that may include an insect repellant composition containing a micellar system and, optionally, an insecticide composition. As an example, an embodiment of the disclosure may include an insect-resistant fabric or garment made from a base fabric (e.g., polyester) including a first region and a second region. The first region of the base fabric may be treated to include an insect repellant composition containing a micellar system. The micellar system of the insect repellant composition may include one or more insect repelling agents (e.g., essential oils) contained within one or more micelles (e.g., saponins). Optionally, the second region of the base fabric may include an insecticide composition (e.g., permethrin).

Aspects of the present disclose may include an insect-resistant fabric or garment including natural ingredients.

Another aspect of the present disclosure may include methods for producing an insect-resistant fabric.

Another aspect of the present disclosure may also include a method for treating a fabric or a garment to enhance insect resistance (e.g., bite protection.)

A further aspect of the present disclosure may include insect-resistant fabrics or garments that demonstrate enhanced insect resistance after applying wear (e.g., washing the garment) and methods to produce the same.

### DETAILED DESCRIPTION

Reference now will be made to the embodiments of the disclosure, one or more examples of which are set forth below. Each example is provided by way of an explanation of the invention and not as a limitation. In fact, it will be apparent to those skilled in the art that various modifications and variations can be made in the disclosed embodiments without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only and is not intended as limiting the broader aspects of the present invention, which broader aspects are embodied exemplary constructions.

Generally speaking, the present disclosure is directed to insect resistance fabrics and garments which can be formed by treating a base fabric or garment with one or more natural or synthetic insect repellant compositions containing a micellar system and, optionally, one or more natural or synthetic insecticides. The micellar system of the present disclosure may include one or more insect repelling agents contained within one or more micelles. By using an insect repellant composition including a micellar system, the embodiments disclosed herein may provide various advantages such as improved insect spatial repelling properties, while also demonstrating enhanced durability and persistency of the insect repellant composition in the base fabric over repeated wear and wash cycles (e.g., time and/or washings.) Alternatively, the present disclosure may be directed to a fabric treated only with an insect repellant composition containing a micellar system, providing a user with significant spatial repelling protection from insects, even after being laundered several laundry cycles. Moreover, the present disclose may be directed to a fabric treated with an insect repellant composition containing a micellar system that includes natural ingredients, such as essential oils and saponins.

As an example, an insect-resistant fabric formed in accordance with disclosure can include an insect repellant composition containing a micellar system. The micellar system may include one or more insect repelling agents (e.g., p-menthane 3,8-diol, lemon eucalyptus extract, citronella extract, etc.) contained within one or more micelles (e.g., saponins). Optionally, an insecticide composition (e.g., permethrin) may bound or otherwise incorporated in a base fabric to form the insect-resistant fabric.

The base fabric, textile substrate, or garment to be treated in accordance with the invention is not limited as to type. Natural and synthetics, such as cotton, rayon, linen, wool, polyester, polyamides (“nylons”), acrylic, cellulose acetate, polyaramide, and polypropylene fabric, as well as blends of these (e.g., cotton and polyester, cotton and nylon) are suitable fabrics in accordance with this disclosure. Additionally, leathers, both natural and man-made, are also contemplated as a garment material suitable for impregnation with an insect repellant and/or an insecticide according to the invention. In an example embodiment of the disclosure, the base fabric includes a polyester fabric. In another example embodiment, the base fabric includes a nylon or a nylon blend. In a further example embodiment, the base fabric includes or otherwise incorporates polyaramides such as poly meta-aramid and poly para-aramid.

An example embodiment of the disclosure may include an insect-resistant fabric. In general, the insect-resistant fabric includes a base fabric treated so that a portion (e.g., a first region) of the base fabric includes an insect repellant composition. Additionally, the insect-resistant fabric may include another portion (e.g., a second region) of the base fabric that includes an insecticide composition. For insect-resistant fabrics produced in accordance with the disclosure, the portion including the insecticide composition and the portion including the insect repellant composition can overlap entirely (e.g., the first region and the second region are the same or the first region includes all of the second region), partially (e.g., the first region includes some of the second region), or not at all (e.g., the first region includes none of the second region.)

Generally, the insecticide composition may include one or more insecticidal agents that function to kill an insect. For embodiments of the disclosure, the insecticide composition may have biocidal activity beyond targeting insects (e.g., the insecticide may also target arachnids, nematodes, or annelids.) In certain embodiments, the insecticide composition can be a broad-spectrum insecticide composition, such that the one or more insecticidal agents can function to kill various insect species (e.g., mosquitos, ants, beetles, flies, bees, etc.) In some embodiments, the insecticide composition may include one or more insecticidal agents tailored to one or more insect species, such that insecticide composition can function to kill only a certain insect species.

A non-limiting example of an insecticide composition in accordance with the disclosure includes pyrethroid compounds. Example pyrethroid compounds include: Allethrin, Bifenthrin, Cyfluthrin, Cypermethrin, Cyphenothrin, Deltamethrin, Esfenvalerate, Etofenprox, Fenpropathrin, Fenvalerate, Flucythrinate, Flumethrin, Imiprothrin, lambda-Cyhalothrin, Metofluthrin, Permethrin, Resmethrin, Silafluofen, Sumithrin, tau-Fluvalinate, Tefluthrin, Tetramethrin, Tralomethrin, Transfluthrin, or combinations thereof.

Generally, the insect repelling composition may include a micellar system. For embodiments of the disclosure, the micellar system may include one or more micelles and one or more insect repelling agents. In one aspect, the one or more insect repelling agents are contained within the one or more micelles of the micellar system.

A micellar system may include one or more micelles in a solution, in which each micelle is a supramolecular assembly of individual amphiphilic molecules. Each amphiphilic molecule includes a hydrophilic “head” region and an opposite hydrophobic “tail” region. In a solution, the dispersion characteristics of the amphiphilic molecules cause the molecules to naturally aggregate with one another and self-assemble to form one or more supramolecular assemblies having a generally spherical shape, referred to as micelles. In each micelle, the hydrophilic “head” region of each amphiphilic molecule is positioned near the surface of the generally spherical shape, while the hydrophobic “tail” region of each amphiphilic molecule points towards the core. For embodiments of the disclosure, any composition including amphiphilic molecules that self-form micelle structures in solution may be included in the micellar system.

A non-limiting example of the one or more micelles in accordance with the present disclosure may include natural micelle-forming ingredients, including one or more saponins. Specifically, the one or more saponins in accordance with the present disclosure may include, among other things, saponins containing extracts of Sapindus mukorossi, Quillaja saponaria, or combinations thereof.

The one or more insect repelling agents may include any compound or combination of compounds that act to disrupt an insect's ability to target a surface or that act to discourage an insect from landing on a surface. For embodiments of the disclosure, the one or more insect repelling agents are generally hydrophobic. Moreover, the insect repelling agents may include a natural repelling agent (e.g., an essential oil), an active compound derived from the natural repelling agent, a synthetic repelling agent, or a combination thereof. However, in particular, certain natural repelling agents, such as essential oils, have been found to demonstrate lower toxicity or irritant properties compared to synthetic repelling agents. As an example, lemon eucalyptus essential oil includes the active compound menthane 3,8-diol, which is generally hydrophobic. Thus, an example insect-resistant fabric, in accordance with the disclosure, can include lemon eucalyptus essential oil and/or menthane 3,8-diol incorporated into a base fabric along with one or more micelles and, optionally, an insecticide.

A non-limiting list of natural repelling agents in accordance with the disclosure includes the essential oils citronella, lemon eucalyptus, lavender, peppermint, sweet basil, catnip, tea tree, rosemary, sage, neem, geranium, garlic, lemongrass, or combinations thereof

A non-limiting list of synthetic repelling agents in accordance with the disclosure includes: Methyl anthranilate and other anthranilate-based insect repellents, Benzaldehyde, N,N-Diethyl-m-toluamide (DEET), Dimethyl carbate, Dimethyl phthalate, Ethylhexanediol, 1-(1-Methylpropoxycarbonyl)-2-(2-hydroxyethyl) piperidine (Picardin), Butopyronoxyl , Ethyl butylacetylaminopropionate,(IR3535) and 2,3,5,6-Tetrafluoro-4-(methoxymethyl) benzyl 2,2-dimethyl-3-(prop-1-en-1-yl)cyclopropanecarboxylate. (Dimefluthrine). 1,2,4-Ethoxyphenyl-2-methylpropoxy methyl-3-phenoxybenzene (Etofenprox), 3,2,2-dichlorovinyl-2,2 dimethylcyclopropanecarboxylic acid (Permethrin)

The one or more insect repelling agents of the present disclosure may be contained within the one or more micelles of the micellar system. Specifically, when hydrophobic molecules (e.g., one or more essential oils) are combined with a solution containing a micellar system (e.g., saponins), each hydrophobic molecule may naturally orient itself in the solution to be contained and “trapped” within the hydrophobic cores of a micelles, resulting in a micellar system of “swollen” micelles.

Without intending to be limited by any particular theory, it is believed that including the above-described micellar system into a fabric gradually delivers the insect repelling agents to the surface of the fabric, while simultaneously protecting the insect repelling agents from evaporation and decomposition. Moreover, it has been shown that incorporating the above-described micellar system into a fabric has resulted in a fabric having improved durability due to fabric/garment wear such as laundering or time. Specifically, by including insect repellant agents contained within a micellar system, fabrics or garments may be produced that demonstrate a high level of insect-resistant efficacy, even after multiple wash cycles. Additionally, the insect-resistant fabrics of the present disclosure have been found to exhibit a high level of insect-resistant efficacy with respect to no-contact spatial repelling properties.

In certain embodiments, the insect-resistant fabric may further include one or more natural binding agents (e.g., a cellulose-based or starch-based binding agent) or one or more synthetic binding agents (e.g., a polyurethane binding agent) to improve retention of the insecticide composition, the insect repellant composition, or both after multiple wash cycles.

Several non-limiting examples of a binding agent that can be used in accordance with this disclosure include: a cellulose binder, a starch binder, a polyester polymer binder, a polyetheramide polymer binder, a polyurethane binder, a DMDHEU/polyol polymer, a cross-linking agent (e.g., a silane), and a dye fixative agent. For example, an insect-resistant fabric in accordance with this disclosure can include a polyurethane binder to improve at least the durability or retention of the insecticide composition or the insect repellant composition. Additionally, or alternatively, the insect-resistant fabric can include the cross-linking agent 3-glycidoxypropyltrimethoxysilane, or a derivative thereof, to improve at least the durability or retention of the insecticide composition or the insect repellant composition in the fabric.

In one embodiment, the insect-resistant fabric or garment may include natural ingredients. For instance, in one example, the insect-resistant fabric of the present disclosure may include one or more natural base fabrics; one or more natural insect repelling agent; optionally, one or more natural binding agents; optionally, one or more natural insecticide composition; or combinations thereof. In this regard, the present disclosure may be directed to an insect-resistant fabric or garment that uses natural ingredients and is perceived by consumers to be safe and environmentally sustainable. Moreover, as synthetic insecticides and insect repellants are oftentimes subject to rigid government regulations, the present disclosure may be directed to an insect-resistant fabric or garment that may be subject to less government regulations.

For certain insect-resistant fabrics and garments in accordance with the disclosure, the addition of a binding agent can be used to improve the retention of the insect repellant composition in the fabric or garment such that an effective amount of the one or more insect repelling agents is present after a number of wash cycles. As used herein, an effective amount of the one or more insect repelling agents can be used to indicate that at least any amount (e.g., as measured by using a speed extractor technique and a gas chromatography technique) of the one or more insect repelling agents remain in the garment.

One aspect of the present disclosure may include a method of measuring the amount of the one or more insect repelling agents in the insect-resistant fabric. The method of measuring the amount of the one or more insect repelling agents may include extracting the one or more insect repelling agents from the fabric and measuring the amount of the one or more insect repelling agents extracted from the fabric.

The one or more insect repelling agents may be extracted from the treated fabric using a variety of techniques. In one aspect, for example, the one or more insect repelling agents may be extracted from the treated fabric using a speed extractor. Specifically, a sample of the treated fabric may be placed in an extraction cell of a speed extractor with one or more glass beads and a dilution solvent. The speed extractor may be operated at a variety of processing conditions to extract the one or more insect repelling agents from the sample of the treated fabric. The extraction step may be performed on one or more samples of the treated fabric and collected to extract a total amount of the one or more insect repelling agents from the insect-resistant fabric. However, other techniques known in the art may be used to extract the one or more insect repelling agents from the insect-resistant fabric.

The total amount of the one or more insect repelling agents extracted from the insect-resistant fabric may be measured using a variety of techniques. In one aspect, the total amount of the one or more insect repelling agents extracted from the insect-resistant fabric may be measured using a gas chromatograph. Specifically, a gas chromatograph may be used to determine a relative response factor for two standard solutions containing the one or more insect repelling agents at a known concentration. Using a calculated average relative response factor, a gas chromatograph may be used to determine the weight of the total amount of one or more insect repelling agents in the insect-resistant fabric.

The first standard solution and second standard solution are prepared using an internal standard. In the present disclosure, the internal standard may be prepared using pure n-tridecane and a dilution solvent (e.g., GC grade acetone).

To prepare a first standard solution, a first solution containing the one or more insect repelling agents at a known concentration is combined with an amount of the internal standard and an amount of dilution solvent. To prepare a second standard solution, a second solution containing the one or more insect repelling agents at a different, known concentration is combined with an amount of the internal standard and an amount of dilution solvent. Aliquots of the first standard solution and the internal standard solution may be injected onto the gas chromatograph to observe peak behavior. This may be repeated for the second standard solution and the internal standard solution.

A relative response factor for each standard solution containing the one or more insect repelling agents at a known concentration may be calculated as shown in Equation I:

$$F = \frac{{A}_{1}}{{A}_{2}} \times \frac{{C}_{2}}{{C}_{1} \times \frac{p}{100 \%}} \qquad ( I )$$

where:
“F” is the calculated relative response factor;
“A₁” is the area of the one or more insect repelling agents peak observed in the gas chromatograph;
“A₂” is the area of the tridecane peak observed in the gas chromatograph;
“C₂” is the concentration of tridecane in the standard solution;
“C₁” is the concentration of the one or more insect repelling agents in the standard solution; and
“p” is the purity, expressed as a percentage value, of the solution containing the one or more insect repelling agents initially added to the standard solution

According to the present disclosure, the first standard solution (which may contain a known amount of p-menthane-3,8-diol) can be inserted into a gas chromatograph with an internal standard at the above conditions. The peak behavior may be observed and recorded to calculate a first relative response factor. A second standard solution (which may contain a different, known amount of p-methane-3,8-diol) can be inserted into a gas chromatograph with an internal standard at the above conditions. The peak behavior may be observed and recorded to calculate a second relative response factor.

The relative response factors calculated for each standard solution should be constant under any particular set of gas chromatograph conditions, with normal analytical variability. If desired, this process may be repeated using a third standard solution, fourth standard solution, and so on. The average relative response factor may be calculated by averaging all of the relative response factors calculated. For instance, the average relative response factor may be calculated by averaging the first relative response factor and the second relative response factor.

The weight of one or more insect repelling agents in a treated fabric may be determined by using gas chromatography. Specifically, the extract containing the total amount of the one or more insect repelling agents extracted from the treated fabric may be mixed with n-tridecane and a dilution solvent to obtain an extract injection preparation. The extract mixture may be placed in a gas chromatograph to observe and record peak behavior with respect to an internal standard. The concentration of the one or more insect repelling agents in the extract injection preparation may be calculated as shown in Equation II:

$${C}_{1} = \frac{{A}_{1}}{{A}_{2}} \times \frac{{C}_{2}}{{F}_{avg}} \qquad ( II )$$

where:
“C₁” is the calculated concentration of the one or more insect repelling agents in the extract injection preparation;
“A₁” is the area of the one or more insect repelling agents peak observed in the gas chromatograph;
“A₂” is the area of the tridecane peak observed in the gas chromatograph;
“C₂” is the concentration of tridecane in the extract injection preparation; and
“F_{avg}” is the average of each relative response factor calculated for each standard solution.

The total weight of the one or more insect repelling agents in the extract injection preparation may be calculated by multiplying the above-calculated concentration of the one or more insect repelling agents in the extract injection preparation by the volume of the extract injection preparation. Assuming the extract of each sample of fabric was collected in a single vial and used to prepare the extract injection preparation, the total weight of the one or more insect repelling agents in the extract injection preparation is approximately equal to the total weight of the one or more insect repelling agents in the treated fabric.

In some implementations, the effective amount of the one or more insect repelling agents may be specified as a percentage loss relative to the initial amount of the one or more insect repelling agents in the base fabric. For example, an insect-resistant fabric of the present disclosure can include a fabric treated with a solution containing a micellar system, where micellar system includes one or more insect repelling agents contained within one or more micelles. After washing the fabric over 30 cycles and determining the amount of the one or more insect repelling agents in the fabric material using the above-described methods, the fabric was found to have lost from about 16% to about 32% of the initial amount of the one or more insect repellant agents applied to the fabric, by weight.

As used herein, a wash cycle or laundry cycle can be in accordance with NFPA test 1971, 8-1.2 (or AATCC TM135-2018-1,V, Ai).

In general, the effective amount of the one or more insect repellant agents can be used to indicate at least the presence of some remaining insect repellant agent after a number of wash cycle or can be used to specify a retention of the insect repellant agent. In an example implementation, an insect-resistant fabric in accordance with the disclosure can include a fabric or garment having an effective amount of the one or more insect repellant agents after at least 3 wash cycles such as after at least 4, 5, 6, 7, 8, 9, 10, 15, 20, 25, 30, or greater than 30 wash cycles.

In one embodiment, for instance, greater than about 20% by weight, such as greater than about 30% by weight, such as greater than about 40% by weight, such as greater than about 50% by weight, such as greater than about 60% by weight, such as greater than about 70% by weight, such as even greater than about 80% by weight of the one or more insect repelling agents remain on the fabric even after thirty laundry cycles. For instance, in one aspect, about 84% by weight of the one or more insect repelling agents remains on the fabric after thirty laundry cycles.

For insect-resistant fabrics of the present disclosure, the concentration and/or relative amounts of active materials (e.g., the insecticide composition and the insect repellant composition) can be adjusted to produce various embodiments. As an example, federal guidelines have set targets for permethrin (an example insecticide) concentration in fabric of about 0.52%+/−10% on the weight of fabric. While this concentration has been deemed safe, embodiments of the disclosure can still demonstrate efficacy for insect resistance at lower concentrations of insecticide composition, due at least in part to the inclusion of an insect repellant composition. In particular, certain embodiments may demonstrate insect resistance efficacy without requiring the addition of an insecticide composition. Thus, for certain embodiments the concentration of the insecticide composition can be about 0% to about 10.52% based on the weight of the fabric or garment, such as about 0.5% to about 10%, about 1% to about 9%, about 2% to about 6%, or about 3% to about 5%.

The insect repellant composition, in accordance with this disclosure, may be applied to the fabric at various concentrations. For example, in some embodiments, the concentration of the one or more insect repelling agents in the treated fabric can be about 5.00 g/ m² or less, such as 4.50, 4.00, 3.50, 3.00, 2.50, 2.00, 1.00, 0.90, 0.75, or 0.5 g/m². Generally, the amount of the insect repellant composition applied to the fabric may be a function of, among other variables, the concentration of the insect repellant composition in the treatment solution. For example, in one aspect in which a fabric is treated with a solution containing an insect repellant composition at a concentration of approximately 50 grams per liter, the concentration of the one or more insect repelling agents in the treated fabric can be about 5 g/m². In another aspect, in which a fabric is treated with a solution containing an insect repellant composition at a concentration of approximately 10 grams per liter, the concentration of the one or more insect repelling agents in the treated fabric can be about 1 g/m².

In certain embodiments, it may also be advantageous to produce an unscented fabric or garments, which may utilize a lower insect repellant composition concentration. Therefore, an example concentration range for the one or more insect repelling agents in accordance with example insect-resistant fabrics and garments of the disclosure can be about 0.6 g/m² to about 3 g/m².

In one embodiment, the micellar system of the present disclosure may contain the one or more insect repelling agents in an amount greater than about 60% by weight, such as greater than about 70% by weight, such as greater than about 80% by weight, such as greater than about 90% by weight. The micellar system may contain the one or more micelles in an amount less than about 40% by weight, such as less than about 30% by weight, such as less than about 20% by weight, such as less than about 10% by weight.

In the above embodiment, the one or more insect repelling agents and the one or more micelles may be present in the micellar system at a weight ratio of from about 1.5:1 to about 20:1, such as from about 2:1 to about 20:1, such as from about 5:1 to about 20:1, such as from about 10:1 to about 20:1. Preferably, the one or more insect repelling agents and the one or more micelles are present in the micellar system at a weight ratio of from about 2:1 to about 3:1.

For both active agents (e.g., the insect repelling agent and the insecticidal agent), loss or deactivation over time may lead to reduction in the concentration of each in the insect-resistant fabric. While certain embodiments of the disclosure can provide improved durability of insect-resistant materials, the concentrations of actives in insect-resistant fabrics of the disclosure may change or decrease over time without limiting the scope of these fabrics as embodiments. Additionally, concentrations of the actives can be determined based on the concentration present in a region of the fabric or garment (e.g., the first region) or based on the total area of the fabric or garment. For example, an insect-resistant fabric according to the disclosure may include a base fabric having a first region including an insect repellant having a concentration in the first region of less than or equal to about 5.00 g/m², and a second region overlapping some of the first region including an insecticide having a concentration of about 1.25 g/m² based on the total fabric area. Alternatively, weights of the insect repelling agent can be determined based upon the quantification methods described above.

Insect-resistant fabrics of the present disclosure can demonstrate improved efficacy compared to untreated fabrics. For example, unwashed fabrics containing an insect repellant composition including a micellar system can demonstrate about a 100% improvement in bite protection when compared to untreated fabrics. To state otherwise, unwashed, treated fabrics or garments in accordance with the disclosure may reduce the number of insects landing on the fabric or garment by at least 100% when compared to untreated fabrics. Thus, this disclosure also provides embodiments for enchasing the efficacy (e.g., bite protection) provided by a garment or fabric by incorporating an insect repellant composition into the fabric.

Moreover, insect-resistant fabrics of the present disclosure can demonstrate improved efficacy compared to untreated fabrics, even after multiple wash cycles. For example, fabrics containing an insect repellant composition including a micellar system, after having undergone at least 10 wash cycles, such as at least 15 wash cycles, such as at least 20 wash cycles, such as at least 25 wash cycles, such as at least 30 wash cycles, may demonstrate from about a 96.5% to about a 100% of an improvement in bite protection when compared to untreated fabrics. To state otherwise, treated fabrics or garments in accordance with the disclosure may reduce the number of insects landing on the treated fabric or garment by at least 96.5% when compared to untreated fabrics, even after treated fabric or garment has undergone a large number of wash cycles. Thus, this disclosure also provides embodiments for enchasing the efficacy (e.g., bite protection) provided by a garment or fabric by incorporating a durable, persistent insect repellant composition into the fabric.

In addition, 68% or more of the micellar system is retained on the insect-resistant fabric of the present disclosure after at least 10 wash cycles, such as at least 15 wash cycles, such as at least 20 wash cycles, such as at least 25 wash cycles, such as at least 30 wash cycles.

As an example, embodiments of the disclosure can include methods for treating a fabric to enhance bite protection. These methods can include administering a solution containing a micellar system to the fabric where the micellar system includes one or more micelles and one or more insect repelling agents. In some of these embodiments, a binding agent may also be applied to the fabric. Post-treatment, the unwashed fabric can display enhanced bite protection, such that using an arm-in-cage test, bite protection is improved by 100%.

Additional aspects of the disclosure can include methods for producing an insect-resistant fabric or garment. For example, a method for producing an insect-resistant fabric or insect-resistant garment in accordance with this disclosure can include applying a treatment to a base fabric or a garment. Generally, the treatment includes applying one or more solutions that include an insect repellant composition containing a micellar system and a binding agent as described herein. However, some methods do not utilize a binding agent. Example methods are disclosed in further detail in Example 1: Methods: Treatment methods.

In an example embodiment, applying the treatment can include immersing the base fabric in one solution that contains the insect repellant composition containing a micellar system and a binding agent.

In another example embodiment, applying the treatment can include spraying the base fabric or the garment with one solution, the one solution including the insect repellant composition and the binding agent.

In another example embodiment, applying the treatment can include using an exhaust application, which includes impregnating the base fabric using an industrial washing machine having a rotatable drum in a bath containing the insect repellant composition.

In another example embodiment, applying the treatment can include spraying the base fabric or garment with a solution containing an insect repellant composition and a binding agent, after the base fabric or garment has been treated by the exhaust application described above.

In general, methods for producing an insect-resistant fabric or insect-resistant garment can first include preparing the one or more solutions that together comprise an insect repellant composition containing a micellar system, optionally a binding agent, and optionally an insecticide composition. Some of the methods according to the disclosure may require preparing only one solution containing the insecticide composition, the insect repellant composition, and the binding agent. In other methods, multiple solutions may be prepared that can then be applied to the fabric or garment in multiple steps that can independently include immersing, spray coating, or laundering.

An example aspect of preparing the one or more solutions can include an insecticide composition concentration, an insect repellant composition concentration, and a binding agent concentration. For instance, the insecticide composition concentration can range from about 0.0 wt % to about 8.0 wt %, such as about 0.5 to about 6.0, about 0.75 to about 4.0, about 0.8 to about 2.0, and about 0.85 to about 1.0 wt %. The insect repellant composition concentration can range from about 0.5 wt % to about 10.0 wt %, such as about 0.6 to about 7.0, about 0.8 to about 5.0, and about 1.0 to about 2.0 wt %. The binding agent concentration can range from about 0.0 wt % to about 8.0 wt %, such as about 0.25 to about 6.0, about 0.5 to about 4.0, and about 1.0 to about 3.0 wt %. As used herein, weight percentages (wt %) are determined based on the total weight of the solution containing the insecticide composition, the insect repellant composition, and/or the binding agent.

In accordance with embodiments of the disclosure, applying the treatment can include immersing the base fabric or the garment in a bath containing a first solution that includes the insect repelling composition to produce a pre-treated material. The pre-treated material can then undergo an additional treatment such as drying to produce a treated material. Spray coating the treated material with a second solution containing the insect repellant composition and the binding agent can then be used to produce a fabric or garment impregnated with a combination of active ingredients in accordance with the disclosure.

In some embodiments, applying the treatment can also include heat-treating the resulting fabric or the garment after applying at least one of the one or more solutions. Heat-treating the resulting fabric or garment includes exposing the resulting fabric or garment to a temperature of about 75° C. to about 120° C., such as, 80° C. to about 110° C., or 90° C. to about 100° C.

### EXAMPLE 1

Example 1 discusses various methods and procedures and provides exemplary embodiments that may be understood in conjunction with the Description provided herein. The materials and methods described are not intended to limit the scope of materials and methods that may be used. Alternatives, generics, modifications, and extrapolations as would be understood by a person of ordinary skill are also contemplated as within the scope of this disclosure.

### METHODS

### Materials

Insect repellant composition: A natural based insect repellant composition was applied to a fabric or garment using the methods below. The insect repellant composition contained a micellar system made up of one or more insect repelling agents and one or more micelles. The insect repellant composition contained the one or more insect repelling agents in an amount greater than or equal to about 70% by weight. The insect repellant composition also contained the one or more micelles in an amount less than or equal to about 30% by weight.

Insect repelling agent: A natural based mosquito repellent such as eucalyptus citriodora oil and/or active ingredient of p-menthane 3,8-diol were used in the micellar system to be applied to a fabric or garment using the methods below.

Micelles: Natural based compounds that form micelle structures, such as saponin derived from Sapindus mukorossi or Quillaja saponaria, were used in the micellar system to be applied to a fabric or garment using the methods below.

Binding agent: A natural based binding agent, such as a binding agent based on starch or cellulose, was used in order to prolong retention of micellar system through frequent wash cycles. A synthetic binding agent, such a binding agent based on polyurethane is used to improve adhesion between fibers and the insect repellant composition

### Treatment Methods

Method 1: Fabric can be polymer-coated with a combination of a binding agent and insect repellent composition containing a micellar system through a one-step conventional pad application method. In this method, a fabric is immersed in a liquid emulsion and then passed through nip rollers to remove excess amount of the finishing mix in order to yield desire wet pick up. The emulsion includes the insect repellant composition in an amount of from about 1% to about 5% by weight. The emulsion also includes a binding agent in an amount of about 1% weight. The fabric was padded with 60-70% wet pick up and dried by process heating at 145° C. (293° F.).

Method 2: Fabric may be sprayed with an insect repellant composition containing a micellar system through a surface coating application (e.g., spray coating) using a binding agent and dried by process heating at 145° C. (293° F.). Spray coating may be used alone or in combination with other impregnation methods.

Method 3: Fabric may be impregnated with an insect repellant composition containing a micellar system through an exhaust application method. For instance, the fabric was processed with jet dyeing machine in continuous loop where the ratio of the volume of the bath, in liters, to the dry weight of the fabric, in g, was about 15:1. The bath was set at 100° F. Up to 5% by weight, active ingredients including micellar oil of lemon eucalyptus with 0.5% by weight binder were added to the bath within 10 minutes. The bath temperature reach to 120° F. at 6° F./min and hold for 30 minutes. Fabric may be impregnated through exhaust process and spray coated (Method 2) using additional additives including binder.

Method 4: Fabric and garment impregnation with insect repellent composition through exhaust application. For instance, an industrial washing machine having a rotatable drum may be used to impregnate the fabric and/or garment. The bath included the micellar system in an amount of about 1%-5% by weight including 0.5%-1% by weight binder. The bath temperate reach to 120 -150° F. and agitate for 30 minutes. After the fabric is impregnated with insect repellant composition the fabric may be placed in an industrial garment dryer at least for one minutes at 250° F.

Quantification Analysis

Speed Extraction

P-menthane-3,8-diol (PMD) was extracted from treated fabric in an extraction step. A speed extractor was used with gas chromatography (GC) grade acetone as a dilution solvent under the following conditions:

TABLE 1
Speed extractor operating conditions

| Sample size of treated fabric | 144 cm² or selected area |
|---|---|
| Temperature | 125° C. |
| Pressure | 100 bar |
| Gas | Nitrogen |
| Vial size | 20 ml |
| Cell size | 10 ml |
| Weight of glass beads | Variable |
| Heat-up time | 1 minute |
| Hold time | 5 minutes |
| Discharge time | 2 minutes |
| Number of cycles | 2 |

Samples were cut from a fabric treated with PMD to have an area of about 144 cm² and weighed. The samples were then placed in extraction cells of the speed extractor. Each extraction cell was filled with glass beads until the total weight of the contents of each extraction cell was about 5 g. For example, if a sample of treated fabric weighing about 1 g was placed in an extraction cell, about 4 g of glass beads were also placed in the extraction cell. If a sample of treated fabric weighing about 3 g was placed in an extraction cell, about 2 g of glass beads were also placed in the extraction cell.

The speed extractor was operated at the conditions above with GC grade acetone as a dilution solvent. The treated fabric was cut into samples and the samples underwent extraction until all of the treated fabric was used. The individual extract of each sample was collected into a single vial to obtain a single vial containing the total amount of PMD extracted from the treated fabric.

Gas Chromatography

A gas chromatograph was used to determine the amount of PMD in the single vial containing the total amount of PMD extracted from the treated fabric. A gas chromatograph was operated at the following conditions:

TABLE 2
Gas chromatograph operating conditions

| | |
|---|---|
| Column | Restek 350° C. |
| | 30 m length × 250 μm I.D. × 0.25 μm film |
| | thickness |
| Initial oven temperature | 90° C., hold 1 minute |
| Final oven temperature | 300° C. |
| Temperature ramp | 25° C./min |
| Injection temperature | 250° C. |
| Detector temperature | 280° C. |
| Injection volume | l μL |
| Split ratio | 20:1 |
| Column flow rate | 1.75 mL/min |

To prepare an internal standard, about 1.0 g of pure n-tridecane was weighed into a tared 100 ml volumetric flask. A dilution solvent (e.g., gas chromatography grade acetone) was poured into the volumetric flask until it contained the volume required.

To prepare a first standard solution, about 60 mg of cis-PMD (of a known concentration) was weighed into a tared 50 ml volumetric flask. About 5 ml of the internal standard solution was added by pipette, and a dilution solvent (e.g., gas chromatography grade acetone) was poured into the volumetric flask until it contained the volume required.

To prepare a second standard solution, about 100 mg of cis-PMD (of a known concentration) was weighed into a tared 50 ml volumetric flask. About 5 ml of the internal standard solution was added by pipette, and a dilution solvent (e.g., gas chromatography grade acetone) was poured into the volumetric flask until it contained the volume required.

The first standard solution and the internal standard solution were inserted into a gas chromatograph at the above conditions, and a first relative response factor was calculated as described in the present disclosure. This was repeated for the second standard solution and the internal standard solution, to calculate a second relative response factor. The first relative response factor and second relative response factor were then averaged to obtain an average relative response factor.

The amount of PMD in the treated fabric was measured by placing the total amount of PCD extracted from the fabric into a 25 ml volumetric flask. About 2.5 ml of pure n-tridecane was added into the flask, and the flask was then filled with a dilution solvent (e.g., gas chromatograph grade acetone) until it contained the volume required. The flask was shaken to mix its contents.

The concentration of PMD in the extract solution, and the weight of PMD in the extract solution, was calculated as described in the present disclosure. Using the weight of PMD in the extract solution and the weight of PMD initially used to treat the fabric product, the amount of PMD retained in the fabric product was calculated.

Results

Results provided and described herein are meant to be exemplary and are not intended to limit the methods and compositions to modifications or alternatives as would be understood by a person of ordinary skill in the field of endeavor.

### Bite Protection

The biting and landing protection of treated fabrics was evaluated by Arm-in-Cage testing. Total of 200 mosquitoes were transferred into the cage with a dimension of 30×45×45 cm (12×18×18 in). A forearm covered with treated fabric and the opposite arm covered with untreated, unwashed fabric (control) were inserted to the cage. Protective gloves were used on hands for bite protection. The number of mosquito landing or probing was recorded during 15 minutes.

Initial results using Anopheles quadrimaculatus in cage showed that an unwashed NyCo and Polyester fabric treated with a micellar system including PMD and saponins exhibits a 100% reduction of the number of mosquito landings on treated, unwashed fabric, as compared to untreated, unwashed fabric.

Under the same conditions as described above, untreated, unwashed fabric (control) was tested against treated fabric after having undergone 30 wash cycles. Initial results showed that the treated, 30× washed fabric demonstrated a reduction of from about 96.5% to about 100% of the number of mosquito landings, compared to untreated, unwashed fabric.

### Durability and Retention

Fabric products were treated with an insect repellant composition containing a micellar system according to the treatment methods described above. The amount of insect repellant composition retained in the fabric was calculated using the quantification method described above after the fabric products had undergone thirty wash cycles. It was discovered that between about 68% and about 84% of PMD was retained on the treated fabrics after having undergone thirty wash cycles.

1. An insect-resistant fabric comprising:
a base fabric comprising a first region and a second region;
the first region comprising an insect repellant composition, wherein the insect repellant composition comprises a micellar system; and
optionally, the second region comprising an insecticide composition;
wherein the first region of the base fabric includes some, all, or none of the second region of the base fabric.

2. The insect-resistant fabric of claim 1, wherein the micellar system comprises one or more insect repelling agents and one or more micelles.

3. The insect-resistant fabric of claim 2, wherein the one or more insect repelling agents are contained within the one or more micelles.

4. The insect-resistant fabric of claim 3, wherein the one or more insect repelling agents comprise one or more essential oils.

5. The insect-resistant fabric of claim 4, wherein the one or more essential oils comprise citronella, lemon eucalyptus, lavender, peppermint, sweet basil, catnip, tea tree, sage, neem, geranium, garlic, lemongrass, or combinations thereof.

6. The insect-resistant fabric of claim 3, wherein the one or more insect repelling agents comprise p-menthane 3,8-diol.

7. The insect-resistant fabric of claim 3, wherein the one or more micelles comprise one or more saponins.

8. The insect-resistant fabric of claim 7, wherein the one or more saponins comprise extracts of Sapindus mukorossi, Quillaja saponaria, or combinations thereof.

9. The insect-resistant fabric of claim 1, wherein the base fabric further comprises one or more binding agents comprising a cellulose binder, a starch binder, a polyester polymer binder, a polyetheramide polymer binder, a polyurethane binder, a DMDHEU/polyol polymer, a cross-linking agent, a dye fixative agent, or combinations thereof.

10. The insect-resistant fabric of claim 3, wherein 68% or more of the micellar system is retained on the insect-resistant fabric after at least 10 wash cycles.

11. The insect-resistant fabric of claim 1, wherein the base fabric comprises one or more natural insect repelling agents, one or more natural saponins, optionally one or more natural binding agents, and optionally a natural insecticide agent.

12. The insect-resistant fabric of claim 1, wherein the base fabric comprises the insect repellant composition and the insecticide composition.

13. The insect-resistant fabric of claim 12, wherein the insecticide composition comprises one or more pyrethroid compounds.

14. The insect-resistant fabric of claim 14, wherein the one or more pyrethroid compounds comprise permethrin.

15. A method for producing an insect-resistant fabric or an insect-resistant garment comprising:
applying a treatment to a base fabric or a garment, wherein
the treatment includes applying one or more solutions that together comprise an insect repellant composition, optionally an insecticide, and optionally a binding agent; and
the insect repellant composition comprises a micellar system.

16. The method of claim 15, wherein applying the treatment comprises:
immersing the base fabric or the garment in a bath containing one solution, and wherein the one solution comprises the insect repellant composition and the binding agent.

17. The method of claim 15, wherein applying the treatment comprises:
spray coating the fabric or the garment by spraying one solution, wherein the one solution comprises the insect repellant composition and the binding agent.

18. The method of claim 15, wherein applying the treatment comprises:
immersing the base fabric or the garment in a bath containing one solution, and wherein the one solution comprises the insect repellant composition.

19. The method of claim 15, wherein applying the treatment further comprises:
spray coating the fabric or the garment by spraying a second solution, wherein the second solution comprises the insect repellant composition and the binding agent.

20. A method for treating a fabric to enhance bite protection, the method comprising:
administering a solution comprising an insect repellant composition comprising a micellar system and optionally a binding agent to the fabric,
wherein after treating the fabric, bite protection is improved 100% using an arm-in-cage test.
